(19) United States
(12) Patent Application Publication
(10) Pub. No.: US 2006/0279648 A1
(43) Pub. Date: Dec. 14, 2006

(54) Imaging device and digital camera

(75) Inventors: Takehiko Senba, Saitama (JP); Takeshi Misawa, Saitama (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/448,676

(22) Filed: Jun. 8, 2006

(30) Foreign Application Priority Data
Jun. 9, 2005 (JP) 2005-169077

(51) Int. Cl. H04N 5/335

(52) U.S. Cl. 348/294

(57) ABSTRACT

An imaging device includes an image sensor chip and a package for containing the image sensor chip. Formed in the package is a vent hole that is connected to an air pump. In a light receiving area of the image sensor chip, there are photodiodes and microlenses above them. The microlenses are made of a gel-like transparent material. When the internal air pressure of the package is changed by the air pump, each microlens transforms in response to the change of the internal air pressure, and thereby changes the surface curvature thereof.

### BACKGROUND OF THE INVENTION

1. Field of the Invention

The present invention relates to imaging devices and digital cameras, and more particularly to an imaging device and a digital camera which use an image sensor chip having microlenses on photodiodes.

2. Description Related to the Prior Art

Typical conventional imaging devices use a box-like package to contain an image sensor chip such as CCD image sensor or CMOS image sensor. Inside the package, the image sensor chip is connected to leads of the package through bonding wires, and the package is sealed with a transparent plate called a cover. The image sensor chip, for example, the CCD image sensor is made of a chip substrate whose top surface accommodates various component, such as a plurality of photodiodes that constitute a light receiving area, gate electrodes for reading out electric charges from the photodiodes, vertical transfer CCDs and a horizontal transfer CCD for transferring the electric charges read out by the gate electrodes. The gate electrodes, the vertical transfer CCDs, and the horizontal transfer CCD are covered by a light shielding layer.

The image sensor chip also has microlenses above the photodiodes which perform a photoelectric conversion. The microlenses condense the incident light onto the photodiodes, and thereby quantum efficiencies of the photodiodes and thus the sensitivity of the image sensor chip are improved.

The microlenses are formed by, for example, a reflow method, an ion diffusion method, or an ink jet method. The reflow method is one that firstly forms a photoresist pattern of cylinder shape on each of the photodiodes by a photolithography technique and then heats up them to flow the photoresist, which turns into the shape of the microlense due to the surface tension thereof. The ion diffusion method is one that diffuses ions onto a glass substrate on which a mask of microlens shape is formed, so that the glass substrate becomes to have a gradual change in refractive index. The ink jet method is one that drops tiny amount of resin on predetermined positions using an ink jet printer head. The resin turns into the shape of the microlenses due to the surface tension thereof.

With these microlens formation methods, the shape and refractive index distribution of the microlenses rely mainly on natural result of the surface tension or the ion diffusion. Accordingly, the microlenses do not always have a desired shape or index distribution, and sometimes fail to perform an acceptable light condensing operation. The Japanese patent laid-open publication No.2002-237582 discloses an insulation film, placed between the gate electrode and the light shielding layer, for controlling the shape of the microlens. The thickness of the insulation film is changed later to control the curvature of the microlens.

Meanwhile, there is a gel of barium titanate (BaTiO₃) with translucency or transparency (see, for example, the Japanese patent laid-open publication No.2000-128631). Such barium titanate gel maintains the transparency after it dries.

According to the Japanese patent laid-open publication No.2002-237582, the curvature of the microlens is determined by the insulating film previously having a certain thickness. It is therefore impossible to adjust the curvature of the microlens according to the focal length and the f-number of an imaging optical system that is used with the image sensor chip.

### SUMMARY OF THE INVENTION

In view of the foregoing, an object of the present invention is to provide an imaging device and a digital camera which can change curvature of microlenses contained in a package.

To achieve the above and other objects, the imaging device according to the present invention includes an image sensor chip whose light receiving area having microlenses made of a gel-like material, a package for containing the image sensor chip, and a vent hole formed on the package for control of air pressure inside the package.

In a preferred embodiment of the present invention, an air pressure regulator is connected to the vent hole. This air pressure regulator controls the air pressure inside the package so that the curvature of the microlens is changed. The package is composed of a package body for containing the image sensor chip and a cover for sealing the package body. Preferably, the vent hole is formed in the package body.

The digital camera of the present invention incorporates the above imaging device, which further includes the air pressure regulator.

According to the present invention, it is possible to adjust the air pressure inside the package that contains the image sensor chip. Since the microlenses made of a gel-like material transform in response to the change of the air pressure inside the package, the curvature of the microlenses can be changed according to the characteristics of an imaging optical system that is used with the image sensor chip. Therefore, the quantum efficiencies of the photodiodes and, thus, the sensitivity of the image sensor chip are improved. Furthermore, the curvature of the microlenses can be changed by the air pressure regulator even after the imaging device has been installed in a digital camera or the like.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a cross sectional view of an imaging device according to the present invention;

FIG. 2A and FIG. 2B are cross sectional views of a light receiving area of an image sensor chip;

FIG. 3 is a block diagram illustrating a constitution of a digital camera according to the present invention.

### DESCRIPTION OF THE PREFFERED EMBODIMENTS

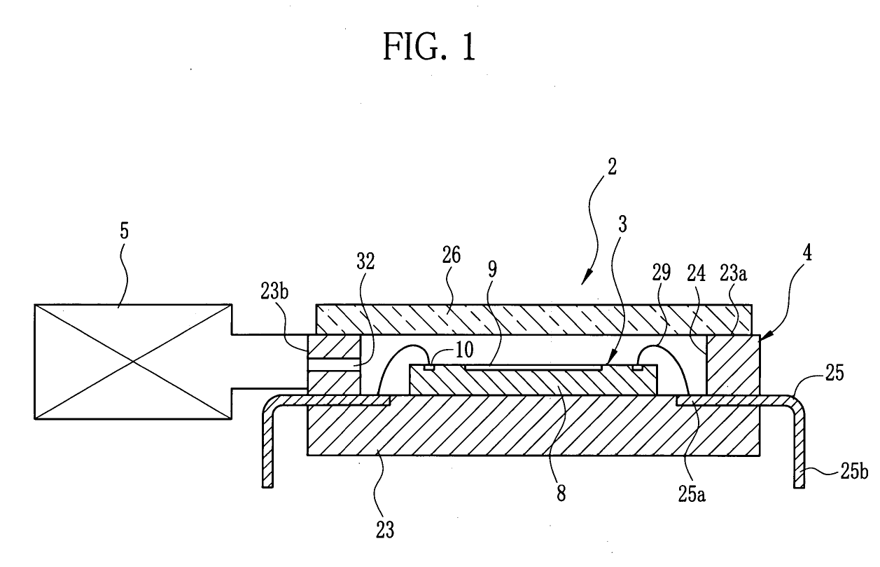

As shown in FIG. 1, an imaging device 2 of the present invention includes an image sensor chip 3, and a package 4 for containing the image sensor chip 3, and an air pump 5 connected to the package 4.

The image sensor chip 3 is composed of a chip substrate 8 of silicon or the like, whose top surface is provided with a light receiving area 9 and plural input/output pads 10. In the light receiving area 9, a plurality of photodiodes that perform a photoelectric conversion are arranged in a matrix from. The input/output pads 10 are electrode pads made of a conductive metal material, and electrically connected to the light receiving area 9.

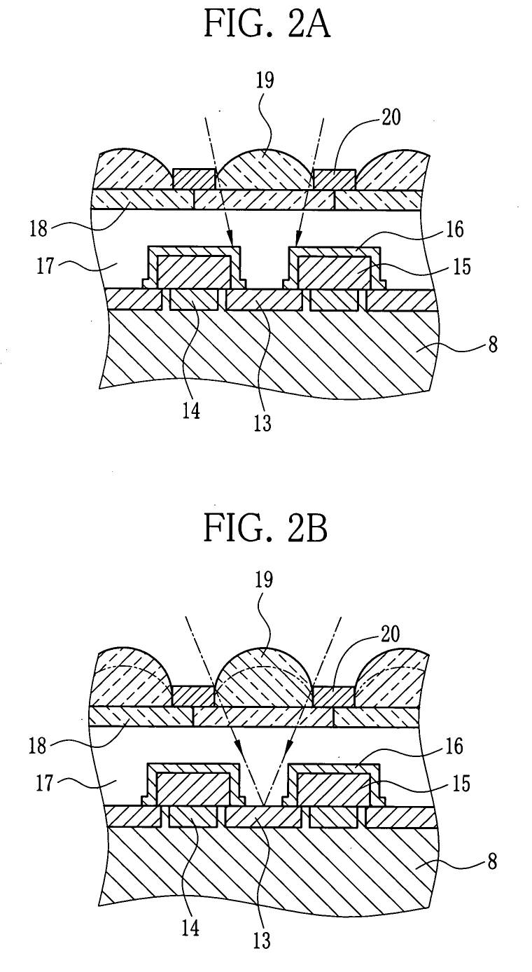

As shown enlarged in FIG. 2A, the light receiving area 9 on the top surface of the chip substrate 8 has photodiodes 13, and a plurality of vertical transfer CCDs 14 for transferring signal charges accumulated in the photodiodes 13. Disposed on the photodiode 13 and the adjoining vertical transfer CCD 14 is an electrode gate 15 which reads out the signal charge from the photodiode 13 and sends it to the vertical transfer CCD 14. Each electrode gate 15 is covered with a light shielding layer 16. The photodiodes 13 and the light shielding layers 16 are covered with a transparent protective layer 17, on which a mosaic color filter 18 of RGB and microlenses 19 are provided. Between the microlenses 19, a light limiting layer 20 is provided.

The microlens 19 is formed of a gel-like transparent material, such as titanium barium disclosed in the Japanese patent laid-open publication No.2000-128631, and has flexibility to transform itself. Each microlense 19 condenses incident light on the corresponding photodiode 13.

The package 4 is composed of a box-like package body 23 made of ceramic or plastic, a depressed chip chamber 24 formed in a top surface 23a of the package body 23, metal leads 25 which are insert-molded in the package body 23, and a cover 26 attached to the top surface 23a of the package body 23 to seal the chip chamber 24.

One end of each lead 25 is an inner lead portion 25a that is exposed inside the chip chamber 24, whereas the other end of the lead 25 is an outer lead portion 25b that projects outside the package body 23. The inner lead portions 25a are connected through bonding wires 29 to the input/output pads 10 of the image sensor chip 3. The cover 26 is made of a transparent material, such as a glass or plastic plate, so as to allow the entrance of light into the image sensor chip 3.

A side face 23b of the package body 23 has a vent hole 32 that penetrates to the chip chamber 24, and an air pump 5 is connected to the vent hole 32. By feeding air into the package 4 through the vent hole 32, the air pump 5 controls air pressure inside the package 4 so that the microlenses 19 change their curvature.

In FIG. 2A, the package 4 has relatively high internal air pressure. Pressed by the high air pressure, the microlenses 19 made of a gel-like material become to have a small curvature. In FIG. 2B, on the contrary, the package 4 has relatively low internal air pressure. As they expand at low air pressure, the microlenses 19 become to have a large curvature. Note that FIG. 2B shows the shapes of the microlenses 19 in FIG. 2A by chain double dashed lines.

As described above, the curvature of the microlenses 19 can be changed even after the image sensor chip 3 is packed in the package 4. Therefore, when the microlenses 19 has the small curvature and the light is blocked its way to the photodiodes 13 by the light shielding layers 16, as shown in FIG. 2A, the air pressure inside the package 4 is lowered to increase the curvature of the microlenses 19. Since the power of the microlenses 19 is thereby increased, the light enters the photodiodes 13 more efficiently. On the other hand, the air pressure inside the package 4 will be raised and the distance between air molecules is reduced, so that thermal conductivity and, thus, heat radiation of the image sensor chip 3 are improved. It is also possible, in this case, to prevent dew condensation in the package 4.

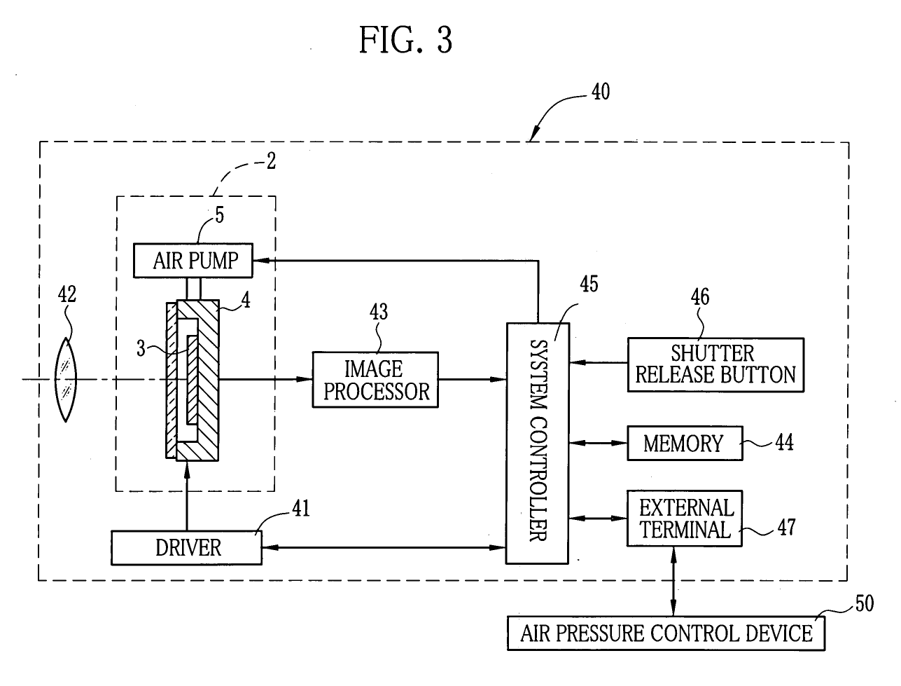

Preferably, such curvature adjustment on the microlenses 19 should be done in an inspection process for the finished imaging devices 2. Furthermore, the curvature adjustment can be done after the imaging device 2 is installed in a digital camera. As shown in FIG. 3, a digital camera 40 is provided with the imaging device 2 composed of the image sensor chip 3, the package 4, and the air pump 5, a driver 41 for operating the image sensor chip 3, a taking lens 42 for focusing subject light on the light receiving area 9 of the image sensor chip 3, an image processor 43 for converting image signals out of the image sensor chip 3 from analog to digital and applying various image processing operations to them, a memory 44 for storing the image signals, a system controller 45 for controlling those components, a common shutter release button 46, and an external terminal 47 for connecting an external device.

The curvature adjust on the microlenses 19 may begin by, for example, connecting an air pressure control device 50 to the external terminal 47. With the digital camera 40 set in an adjustment mode, a test image is taken through the system controller 45 and the resulting image signal is sent to the air pressure control device 50. After detecting the sensitivity of the image sensor chip 3 based on the image signal, the air pressure control device 50 activates the air pump 5 to change the curvature of the microlenses 19 for proper sensitivity of the image sensor chip 3. The microlenses 19 become to have the curvature optimally tuned for the taking lens 42 and other optical components of the digital camera 40, which is then able to ensure better image quality.

Although the air pump is fixed to the imaging device in the above embodiment, the air pump may be connected to an air valve which is formed on the vent hole of the package and be detached when the air pressure regulation of the package is completed. Even though the above embodiment is described with the CCD image sensor, the present invention can be applied to the CMOS image sensor chip.

As described so far, the present invention is not to be limited to the above embodiments, and all matter contained herein is illustrative and does not limit the scope of the present invention. Thus, obvious modifications may be made within the spirit and scope of the appended claims.

What is claimed is:

1. An imaging device comprising:
an image sensor chip whose light receiving area has microlenses made of a gel-like material;
a package for containing said image sensor chip; and
a vent hole formed in said package and allowing a passage of air to control an internal air pressure of said package.

2. An imaging device as claimed in claim 1, wherein said microlenses change curvature of their surfaces according to said internal air pressure.

3. An imaging device as claimed in claim 2, wherein said gel-like material is barium titanate.

4. An imaging device as claimed in claim 2, further comprising:
an air pressure regulator connected to said vent hole and controlling said internal air pressure of said package.

5. An imaging device as claimed in claim 4, wherein said air pressure regulator is an air pump which feeds air into said package.

6. An imaging device as claimed in claim 2, wherein said package including:
a package body for containing said image sensor chip;
a cover for sealing said package body; and
said vent hole formed in said package body.

7. A digital camera having an imaging device for converting images into electric signals, said imaging device comprising:
an image sensor chip whose light receiving area has microlenses made of a gel-like material;
a package for containing said image sensor chip; and
a vent hole formed in said package and allowing a passage of air to control an internal air pressure of said package.

8. A digital camera as claimed in claim 7, further comprising:
an air pressure regulator connected to said vent hole and controlling said internal air pressure of said package.
